(19) United States
(12) Patent Application Publication
(10) Pub. No.: US 2026/0006454 A1
(43) Pub. Date: Jan. 1, 2026

(54) TECHNIQUES FOR DETERMINING AN UPDATED MAXIMUM SUPPORTED BANDWIDTH

(71) Applicant: Lenovo (United States) Inc., Morrisville, NC (US)

(72) Inventors: Daniel C. Chisu, Franklin Park, IL (US); Armin W. Klomsdorf, Chicago, IL (US); Yui J. Chin, Chicago, IL (US)

(21) Appl. No.: 19/322,330

(22) Filed: Sep. 8, 2025

(51) Int. Cl. H04W 16/14; H04W 24/04

(52) U.S. Cl. CPC H04W 16/14; H04W 24/04

(57) ABSTRACT

Various aspects of the present disclosure relate to detecting at least two selection-suitable cells of similar pathloss on a frequency range, each cell associated with a RF channel, and determining a potential RF interference condition between the at least two selection-suitable cells due to overlapping spectra of the associated RF channels. Aspects of the present disclosure relate to determining, for the frequency range, updated maximum supported bandwidths of the UE and transmitting an indication of at least one updated maximum supported bandwidth to a wireless network.

### TECHNICAL FIELD

The present disclosure relates to wireless communications, and more specifically to techniques for determining an updated maximum supported bandwidth for a radio frequency (RF) channel.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to detect at least two selection-suitable cells of similar pathloss on a frequency range, each cell associated with a RF channel; determine a potential RF interference condition between the at least two selection-suitable cells due to overlapping spectra of the associated RF channels; determine, for the frequency range, updated maximum supported bandwidths of the UE; and transmit, to a wireless network, an indication of at least one updated maximum supported bandwidth.

A processor for wireless communication is described. In some examples, the processor may be implemented in a UE. The processor may be configured to, capable of, or operable to detect at least two selection-suitable cells of similar pathloss on a frequency range, each cell associated with a RF channel; determine a potential RF interference condition between the at least two selection-suitable cells due to overlapping spectra of the associated RF channels; determine, for the frequency range, updated maximum supported bandwidths of the UE; and transmit, to a wireless network, an indication of at least one updated maximum supported bandwidth.

A method performed or performable by a UE is described. The method may include detecting at least two selection-suitable cells of similar pathloss on a frequency range, each cell associated with a RF channel; determining a potential RF interference condition between the at least two selection-suitable cells due to overlapping spectra of the associated RF channels; determining, for the frequency range, updated maximum supported bandwidths of the UE; and transmitting, to a wireless network, an indication of at least one updated maximum supported bandwidth.

A NE for wireless communication is described. In some examples, the NE may be implemented in a base station. The NE may be configured to, capable of, or operable to receive, from a stationary UE, a first indication of an updated maximum supported bandwidth of the UE; adjust one or more allocation of RF resources to the UE based on the first indication; and receive a second indication of an interference condition based on potential RF interference condition between at least two selection-suitable cells on a frequency range due to overlapping spectra of associated RF channels.

A processor for wireless communication is described. In some examples, the processor may be implemented in a NE or a base station. The processor may be configured to, capable of, or operable to receive, from a stationary UE, a first indication of an updated maximum supported bandwidth of the UE; adjust one or more allocation of RF resources to the UE based on the first indication; and receive a second indication of an interference condition based on potential RF interference condition between at least two selection-suitable cells on a frequency range due to overlapping spectra of associated RF channels.

A method performed or performable by a NE is described. In some examples, the NE may be implemented in a base station. The method may include receiving, from a stationary UE, a first indication of an updated maximum supported bandwidth of the UE; adjusting one or more allocation of RF resources to the UE based on the first indication; and receiving a second indication of an interference condition based on potential RF interference condition between at least two selection-suitable cells on a frequency range due to overlapping spectra of associated RF channels.

### BRIEF DESCRIPTION OF THE DRAWINGS

FIG. 1 illustrates an example of a wireless communications system in accordance with aspects of the present disclosure.

FIG. 2 illustrates an example of a potential RF interference condition due to overlapping spectra of associated RF channels, in accordance with aspects of the present disclosure.

FIG. 3 illustrates an example of a procedure for determining a potential RF interference condition and determining an updated maximum supported bandwidth for a RF channel, in accordance with aspects of the present disclosure.

FIG. 4 illustrates an example of a procedure for generating a frequency overlap array, in accordance with aspects of the present disclosure.

FIG. 5 illustrates an example of frequency overlap array, in accordance with aspects of the present disclosure.

FIG. 6 illustrates an example of a protocol stack, in accordance with aspects of the present disclosure.

FIG. 7 illustrates an example of a UE, in accordance with aspects of the present disclosure.

FIG. 8 illustrates an example of a processor, in accordance with aspects of the present disclosure.

FIG. 9 illustrates an example of a NE, in accordance with aspects of the present disclosure.

FIG. 10 illustrates a flowchart of a method performed by a UE, in accordance with aspects of the present disclosure.

FIG. 11 illustrates a flowchart of a method performed by an NE, in accordance with aspects of the present disclosure.

### DETAILED DESCRIPTION

In network-controlled wireless systems, base stations are deployed to provide radio access coverage for a plurality of areas. When planning wireless systems, a service provider determines how to deploy the base stations (and corresponding cells) and how to efficiently allocate radio spectrum with the aim to optimize cell coverage, cell capacity, and radio quality. For example, one objective of network planning is to ensure there is signal strength across the intended coverage area to support a target number of users. Another objective of network planning is to limit co-channel and adjacent-channel interference between cells.

To maximize radio access, the licensed radio spectrum (e.g., frequency band or serving band) is divided into RF channels, also referred to as carriers. Each RF channel may be defined by a center frequency and a bandwidth coverage. For example, on the n41 frequency band (i.e., a 5G new radio (NR) frequency band spanning 2496 MHz to 2690 MHz), the absolute radio frequency channel number (ARFCN) 519390 having a 100 MHz bandwidth indicates a carrier with a center frequency of 2596.95 MHz and a spectrum of from 2546.95 MHz to 2646.95 MHz.

To increase spectral efficiency of the frequency band, RF channels may be reused in cells having geographic separation to minimize inter-cell interference. Frequency separation between cells may consider both co-channel separation (i.e., geographic separation of cells using the same RF channel) and adjacent channel separation (i.e., geographic separation of cells using the neighboring RF channels), so that sufficient channel quality is at the cell edges. While network planning aims to minimize inter-cell interference, it may not be possible (or may be impractical) to prevent all instances of inter-cell interference.

Accordingly, real-world network deployments may be unable to achieve the ideals of network planning and may experience co-channel interference or adjacent channels interference, e.g., at cell edges. Additionally, while each service provider may control its own network topology, there may not be any a priori inter-network knowledge on another provider's network topology, thus different service providers in the same geographic area may inadvertently deploy RF channels (e.g., adjacent channels) with overlapping frequencies leading to potential interference situations, especially in new band deployments with large bandwidths.

The inventors have observed, on live networks, evidence that the network planning is not optimal and results in neighbor cell interference conditions. For example, a network evaluator discovered an area where the UE repeatedly lost the wireless connection due to radio link failure caused by an interference condition from overlapping frequencies in nearby cells. Here, the UE detected two primary ARFCNs of similar power and insufficient center frequency separation leading to an overlapping bandwidth. As a result, the UE, located midway between the two cells, may experience an interference condition due to the bandwidth overlap.

This type of interference scenario, where the device operates midway between two or more RF channels with overlapping frequencies, has resulted in repeated poor device performance by the evaluator. This poor device performance may be further exacerbated in locations that do not have strict spectrum allocation controls and may also arise in some shared spectrum conditions (i.e., operations on unlicensed bands). While network planning aims to minimize inter-cell interference, it may not be possible (or may be impractical) to prevent all instances of inter-cell interference due to adjacent RF channels with overlapping frequencies.

Aspects of the present disclosure describe techniques for mitigating inter-cell interference, e.g., due to adjacent RF channels with overlapping frequencies. Beneficially, the techniques described herein improve the user experience by detecting potential interference situations and modifying a device-specific operating bandwidth to minimize communication activities of the device in the overlapping frequencies.

A first solution describes a procedure to detect a potential interference situation by examining over-the-air (OTA) overheads, such as system information (SI) broadcasts, and without requiring the UE to scan the frequencies for actual interference. In some implementations, the UE that detects the potential interference situation may notify the wireless network. In some implementations, a UE with multiple subscriber identity modules (SIMs), such as a dual SIM dual standby (DSDS) device, may determine potential inter-network interference due to adjacent RF channels with overlapping frequencies and notify one or both networks of the potential interference situation.

A second solution describes a procedure to adjust an operating bandwidth (BW) based on the potential interference situation, and signaling an updated BW to the wireless network. In some implementations, the UE may notify the wireless network by transmitting a UE capability information (UCI) update message.

While presented as distinct solutions, one or more of the solutions described herein may be implemented in combination with each other. Additional aspects are disclosed that may be used in combination with the first solution or the second solution (or a combination thereof), or may be implemented independent of the first or second solutions. Aspects of the present disclosure are described in the context of a wireless communications system.

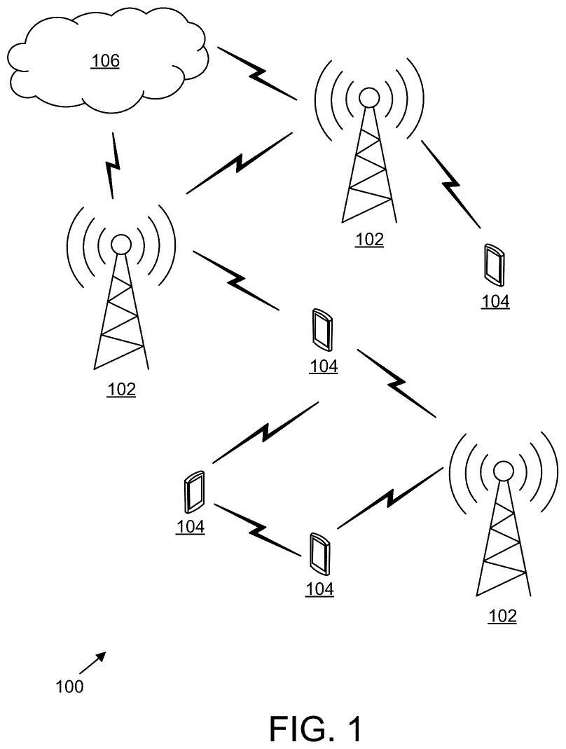

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., u=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration .

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

According to implementations, one or more of the NEs 102 and the UEs 104 are operable to implement various aspects of the techniques described with reference to the present disclosure.

In some implementations, a UE 104 may detect at least two selection-suitable cells of similar pathloss at on a frequency range, each cell associated with a RF channel. In some implementations, each cell is associated with a different NE 102. In certain implementations, the UE 104 detects the at least two selection-suitable cells in response to experiencing a failure condition and also in response to determining that a stationary threshold is satisfied.

Additionally, the UE 104 may determine a potential RF interference condition between the at least two selection-suitable cells due to overlapping spectra of the associated RF channels and determine, for the frequency range, updated maximum supported bandwidths of the UE 104. Moreover, the UE 104 may transmit a first indication of at least one updated maximum supported bandwidth.

In some examples, an NE 102, upon receiving the first indication of an updated maximum supported bandwidth, may adjust one or more allocation of RF resources to the UE based on the first indication. For example, the NE 102 may adjust an operating bandwidth of a cell based on the received updated maximum supported bandwidth.

In certain implementations, the NE 102 may receive a second indication of an interference condition based on potential RF interference condition between at least two selection-suitable cells on a frequency range due to overlapping spectra of associated RF channels. In one example, the indication of an interference condition is an indication of a potential inter-frequency interference condition, where the two or more selection-suitable cells have different center frequencies. In another example, the indication of an interference condition is an indication of a potential intra-frequency interference condition, where the two or more selection-suitable cells may have the same center frequency.

Because it may be impractical to resolve a potential interference condition caused by network deployment by changing the actual topology of the interfering spectra, aspects of the present disclosure describe techniques and procedures to modify the device-side response to this interference. In some implementations, the device determines a modified operating bandwidth for the cell (e.g., an updated maximum supported bandwidth of the UE) that utilizes non-interfering spectra.

A first solution describes a procedure to detect a potential interference condition by examining OTA overheads. In response to this detection, the UE may signal an updated BW to the wireless network. A second solution describes a procedure to adjust an operating bandwidth based on the potential interference situation, and signaling an updated BW to the wireless network. In some implementations, the UE may notify the wireless network by transmitting a UCI update message.

For example, a stationary UE which encounters a failure condition (e.g., radio link failure (RLF), data stall, etc.) and is operating in proximity of at least two overlapping frequencies, may adjust its maximum supported bandwidth of the interfering bands, and may signal an UCI update to the wireless network. In some implementations, the wireless network does not assign resources in the interfered spectrum to the UE for at least a time window. In various implementations, the UCI update message indicates the UE's radio capabilities including supported frequency bands, carrier aggregation combinations, multiple-input multiple-output (MIMO) capabilities, modulation schemes, power class, and other features. The wireless network uses this information to configure the UE appropriately and to optimize network performance.

According to aspects of the first solution, a UE (e.g., UE 104) may examine OTA overheads, such as the Master information block (MIB), the system information block #1 (SIB1), or a radio resource control (RRC) reconfiguration message. The MIB and SIB1 comprise cell-specific information and are broadcast by the base station supporting the cell. The RRC reconfiguration message is a downlink (DL) control message and during initial setup, during handover, or when the wireless network decides to modify radio connection parameters.

From the OTA information, the UE may detect a potential interference condition by examining OTA overheads without having to scan the RF frequencies for actual interference. In some implementations, the OTA information includes ARFCN and bandwidth information for RF channels in use near the UE. For example, the ARFCN and bandwidth information indicate the upper bound and lower bound of each RF channel, and the UE may use this information to determine a potential interference condition, e.g., due to adjacent RF channels with overlapping frequencies.

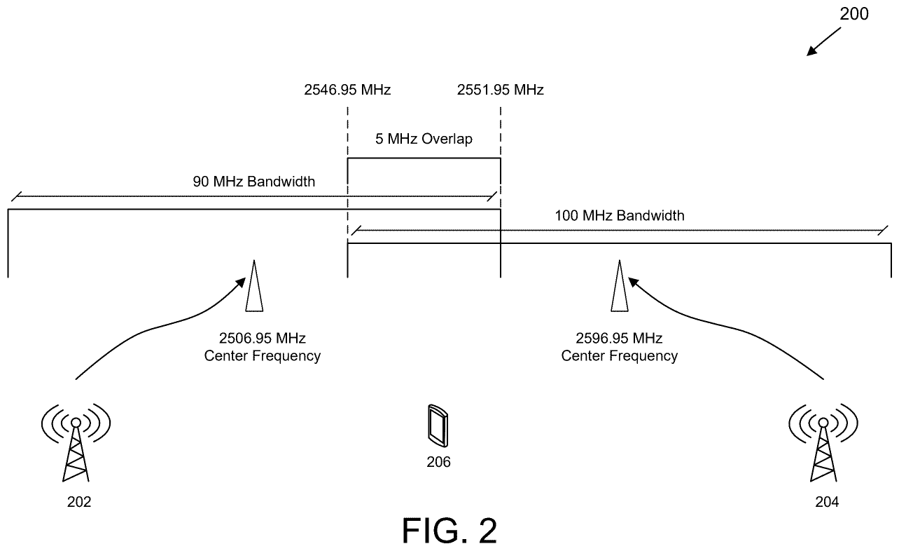

FIG. 2 illustrates an example of a potential RF interference condition 200 due to overlapping spectra of associated RF channels, in accordance with aspects of the present disclosure. The potential RF interference condition 200 may implement or be implemented by aspects of the wireless communication system 100. For example, the potential RF interference condition 200 may be generated by the deployment of one or more base stations, which may be examples of the NE 102, as described herein.

The potential RF interference condition 200 is caused by a first transmit-receive point (TRP) 202 operating on a first RF channel having a center frequency of 2506.95 MHz and a 90 MHz bandwidth, which is in proximity to a second TRP 204 that operates on a second RF channel having a center frequency of 2596.95 MHz and a 100 MHz bandwidth. The proximity of the TRP 202 to the TRP 204 results in an overlap in the coverage areas of the first RF channel and the second RF channels. For example, the first TRP 202 and the second TRP 204 may be adjacent cells, with a first cell corresponding to the first RF channel and a second cell corresponding to the second RF channel. Note that the first TRP 202 and the second TRP 204 may be in the same public land mobile network (PLMN) and operated by the same service provider (e.g., the same mobile network operator (MNO)). Alternatively, the first TRP 202 and the second TRP 204 may be in different PLMNs and/or operated by different service providers (MNOs).

In the depicted example, the first RF channel has an upper bound of 2551.95 MHz, and the second RF channel has a lower bound of 2546.95 MHz, leading to a spectra overlap of 5 MHz. Therefore, a UE 206 positioned between the first TRP 202 and the second TRP 204 may experience interference if it is allocated RF resources with frequencies between 2546.95 MHz and 2551.95 MHz.

As noted above, the UE 206 may detect the potential RF interference condition 200 by reading the OTA information provided by the cells, e.g., provided by the first TRP 202 and/or the second TRP 204 in SI broadcasts or RRC signaling. In various implementations, upon detecting the potential RF interference condition 200, the UE 206 may notify the first TRP 202 and/or the second TRP 204. Thereafter, the first TRP 202 and/or the second TRP 204 may avoid allocating uplink (UL) or downlink (DL) resources to the UE 206. In some implementations, the wireless network(s) temporarily may cease allocating RF resources in the overlapping spectra for a predetermined time period. In some implementations, the wireless network(s) may cease allocating RF resources in the overlapping spectra until the UE leaves the first cell or second cell. Moreover, the wireless network may avoid allocating RF resources in the overlapping spectra to all UE near the cell boundaries.

According to aspects of the second solution, in response to experiencing a radio failure condition, a UE (e.g., UE 104) may perform a system determination (SD) scan to determine a potential interference situation and adjust a maximum supported bandwidth based on the potential interference situation.

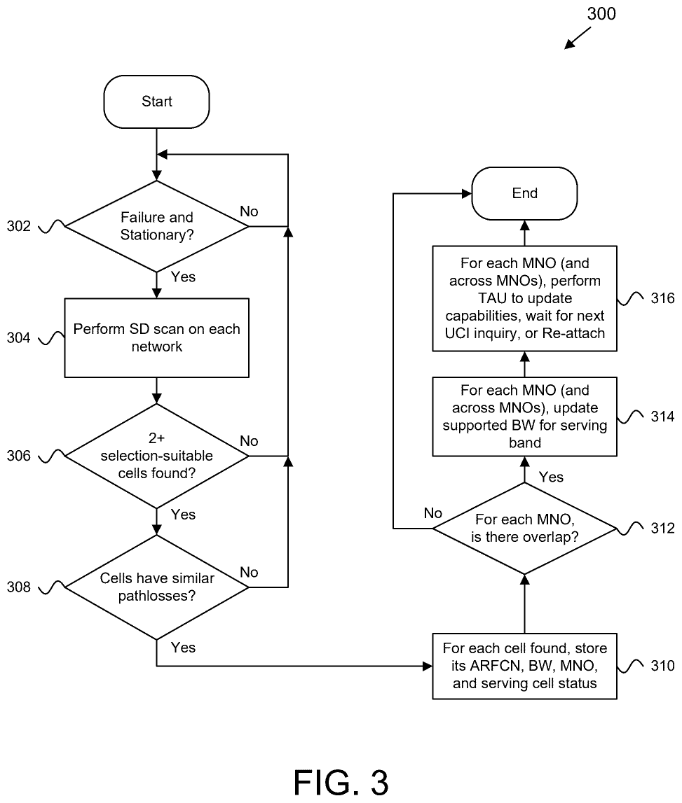

FIG. 3 illustrates an example of a procedure 300 for determining a potential RF interference condition and determining an updated maximum supported bandwidth for a RF channel, in accordance with aspects of the present disclosure. The procedure 300 may implement or be implemented by aspects of the wireless communication system 100. For example, the procedure 300 may be performed by a UE, which may be an example of the UE 104, as described herein.

The procedure 300 begins and the UE determines 302 whether the UE encounters a failure condition while in a stationary state. For example, the failure condition may include an instance of RLF or a service failure, such as a data stall condition or a dropped call. As another example, the failure condition may be triggered when a detected quality falls below a quality threshold. For example, the UE may experience a degradation in call quality comprising the quality of media data received-in terms of packet stream quality, speech frame quality, packet jitter (e.g. variation in inter-packet delay), packet latency, packet loss, audio quality (e.g., based on an objective mean opinion score (MOS) estimated using objective measurements, such as packet jitter, packet latency, and packet loss, or similar metrics), and so forth.

Additionally, the stationary state may be identified using a threshold, such that the UE is determined to be in the stationary state whenever the movement of the UE is less than a stationary threshold. Similarly, the UE may determine to be in a mobile state whenever the movement of the UE exceeds a mobility threshold. In some implementations, the stationary threshold and the mobility threshold may be the same threshold, i.e., having the same value. In other implementations, the mobility threshold may be higher than the stationary threshold to avoid rapid cycling between the stationary and mobility states.

If the UE is not stationary when the failure condition is detected, then the failure condition may be transient and bandwidth optimization by determining an updated maximum supported bandwidth for a RF channel may not be beneficial to the UE, therefore the procedure 30 may end. Alternatively, the UE may return to monitoring for a failure condition experienced while in a stationary state.

Otherwise, if the UE is stationary when the failure condition is detected, then the UE may perform 304 a system determination (SD) scan for each network. The SD scan refers to a scan of frequencies for cell detection and system information acquisition. In some implementations, the UE includes a single SIM and is configured to scan for cells on frequencies associated with the MNO (i.e., service provider) of the SIM. In certain implementations, the UE may include multiple SIMS and thus may be configured to scan for cells on frequencies associated with each MNO corresponding to a SIM. In other implementations, the UE may scan for cells on frequencies associated with multiple MNOs, regardless of whether the UE includes a single SIM or multiple SIMs.

After performing the SD scan to determine radio coverage at the UE's location, the UE may then perform cell selection to determine 306 whether multiple selection-suitable cells are found. In some implementations, the UE may have recently performed an SD scan and therefore may use stored data for determining a potential RF interference condition and determining an updated maximum supported bandwidth for a RF channel. For example, if a freshness condition is met, then the UE may bypass step 304 and proceed with cell selection.

As used herein, a “selection-suitable cell” refers to a cell that belongs to an acceptable PLMN (i.e. belonging to an MNO with which the UE has a service agreement) and is not barred (i.e., the selection is not forbidden), and that meets cell selection criteria, for example having cell signal strength and/or signal quality that satisfy threshold value(s). If only a single selection-suitable cell is detected (or if no selection-suitable cells are detected) then further optimization is not needed to address a potential interference condition, and the procedure 300 may end. Alternatively, the UE may return to monitoring for a failure condition experienced while in a stationary state.

Otherwise, if multiple selection-suitable cells are detected, the UE may determine 308 whether the multiple selection-suitable cells have similar pathlosses. For example, if the UE is located halfway between the two cells (i.e., being a similar distance from the cells' TRPs), then the selection-suitable cells may have similar pathlosses. Other factors that determine the pathloss include the transmit power of the cell and environmental conditions causing signal attenuation. In various implementations, the UE will detect cells with similar pathlosses when the UE is located near the boundaries (i.e., cell edges) of two or more cells.

In some implementations, the UE's pathloss estimate may be based on the transmit power (P_tx) of the cell and the reference signal received power (RSRP) measured by the UE, represented as:

$$Pathloss = P\_tx - RSRP$$

where P_tx is the transmit power per reference signal (i.e., broadcast by the wireless network in SIBs).

A primary factor in declaring that two cells are of similar (i.e., equivalent) pathloss is the measured RSRP from each cell, also referred to as the RSRP proximity. If, after accounting for any cell-specific offsets or biases, the RSRP values of two cells are very close to each other (i.e., within a predetermined or configured threshold), then the UE will perceive their pathloss as similar. This means the signals are attenuated similarly as they travel from the base station (TPR) to the UE. As RSRP is part of the pathloss calculation, the pathloss delta between the two cells should not exceed a network-defined threshold (e.g., <3 dB) for two cells to be determined as having equivalent pathloss. This delta may be configured by the wireless network and may be specific to the particular scenario (e.g., intra-frequency, inter-frequency, inter-RAT reselection).

Additional factors in declaring that two cells are of similar (i.e., equivalent) pathloss include the cells' transmit power and the reference signal received quality (RSRQ) determined by the UE. For example, cells with equivalent pathloss may not have large differences in the cells' transmit power, otherwise the pathloss calculation could make them non-equivalent, even if RSRP measurements appear similar. Additionally, the cells' signal quality (i.e., RSRQ) should not differ significantly, otherwise the pathloss determination could make them non-equivalent, even if RSRP measurements appear similar.

If the selection-suitable cells do not have similar pathlosses, then the radio failure condition is unlikely to be from the potential interference condition and modifying the maximum supported bandwidth is unlikely to resolve the failure condition, therefore in certain implementations the procedure 300 may end upon determining that the selection-suitable cells do not have similar pathlosses. Alternatively, the UE may return to monitoring for a failure condition experienced while in a stationary state.

Otherwise, if at least two selection-suitable cells have similar pathlosses, then the UE may store 310 cell information, such as the ARFCN, the BW, the associated MNO, and the serving cell status. In some implementations, the UE may generate a frequency overlap array in which the cell information is stored.

In certain implementations, a cell may have a network-defined priority to be used by the UE to determine which cell and/or frequency to prioritize when multiple cells are available and suitable. While this priority may be used to select the serving cell, the priority may not be relevant to determining the potential interference condition, and therefore may be omitted from the frequency overlap array.

For each MNO, and across MNOs, the UE determines 312 there is overlapping spectra. If the selection-suitable cells do not have overlapping spectra, then the radio failure condition is not due to overlapping spectra of associated RF channels, and the procedure 300 ends.

Otherwise, if at least two selection-suitable cells have overlapping spectra, then for each MNO, and across MNOs, the UE updates 314 at least one maximum supported bandwidth for the cells with overlapping spectra. The bandwidth optimizations are stored in local memory. In some implementations, the UE determines updated maximum supported bandwidths on a cell-by-cell basis for each of the cells with overlapping spectra. In some other implementations, the UE determines a single updated maximum supported bandwidth that is applied to all the cells with overlapping spectra. In certain implementations, the UE determines updated maximum supported bandwidths only for serving cells. In certain other implementations, the UE determines updated maximum supported bandwidths for both serving cells and non-serving cells.

For each MNO, and across MNOs, the UE may also signal 316 an indication of the updated maximum supported bandwidth(s) to the wireless network, e.g., by performing a tracking area update (TAU) procedure to update the UE capabilities, or waiting for a next UCI inquiry, or by performing a re-attach procedure. The procedure 300 ends.

In some implementations, the UE may implement a modified procedure where upon encountering a failure condition while in the stationary state, the UE checks whether bandwidth optimizations, as described in step 314, were recently performed and may terminate the procedure 300 if the bandwidth optimizations were recently performed. Moreover, the UE may revert (i.e., undo) the bandwidth optimizations when it is no longer stationary (i.e., when the stationary threshold is no longer satisfied and/or when the mobility threshold is satisfied) since the pathloss conditions are likely to have changed since the bandwidth optimization was performed. Additionally, the UE may revert the bandwidth optimizations when the failure condition is resolved, or after a certain amount of time has passed (i.e., when the bandwidth optimization is no longer fresh).

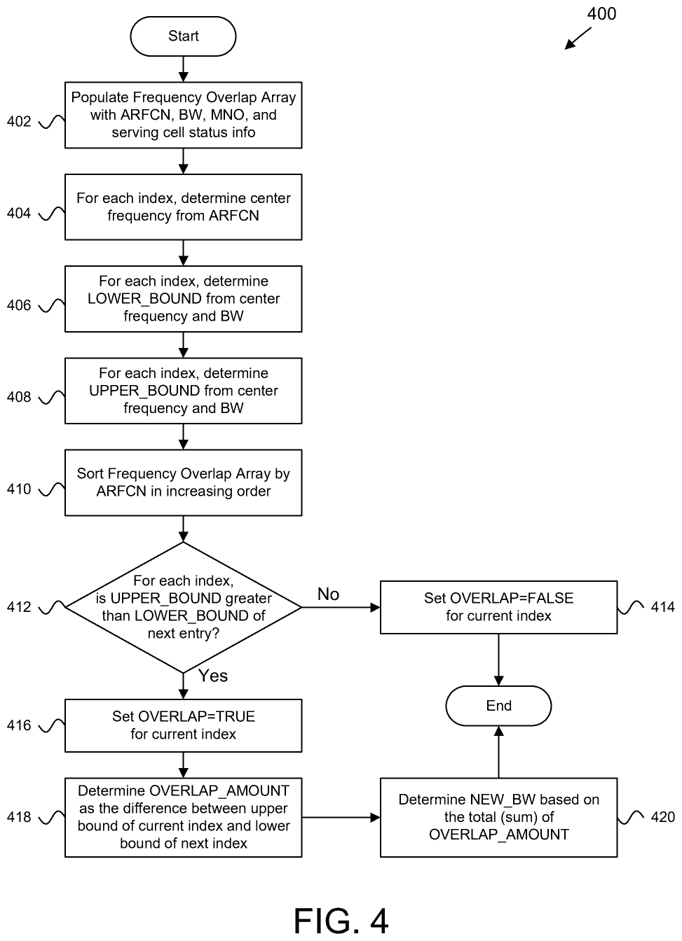

FIG. 4 illustrates an example of a procedure 400 for generating a frequency overlap array for a plurality of RF channels, in accordance with aspects of the present disclosure. The procedure 400 may implement or be implemented by aspects of the wireless communication system 100. For example, the procedure 400 may be performed by a UE, which may be an example of the UE 104, as described herein. In some implementations, the procedure 400 is used to store cell information as described in step 310 of FIG. 3.

The procedure 400 begins and the UE populates 402 the frequency overlap array with cell information comprising ARFCN, BW, MNO, and serving cell status. In certain examples, the frequency overlap array may omit the MNO and serving cell status.

For each index of the frequency overlap array, the UE determines 404 the center frequency of the corresponding RF channel from the ARFCN. For example, for RF channels 3 GHz and lower, the ARFCN range may be from 0 to 599999, and the ARFCN may be mapped to the center frequency (CENTER_FREQ) as follows:

$$CENTER\_FREQ ( MHz ) = ARFCN \times 0.005$$

As another example, for RF channels between 3 GHz and 24.25 GHz, the ARFCN range may be from 600000 to 2016666, and the ARFCN may be mapped to the center frequency (CENTER_FREQ) as follows:

$$CENTER\_FREQ ( MHz ) = 3000 + ( ARFCN - 600000 ) \times 0.015$$

As yet another example, for RF channels between 24.25 GHz and 100 GHz, the ARFCN may be from 2016667 to 3279165, and the ARFCN may be mapped to the center frequency (CENTER_FREQ) as follows:

$$CENTER\_FREQ ( MHz ) = 24250 + ( ARFCN - 2016667 ) \times 0.06$$

For each index of the frequency overlap array, the UE determines 406 the lower bound (LOWER_BOUND) of the RF channel based on the center frequency and BW. For example, the center frequency and BW relates to the lower bound as follows:

$$LOWER\_BOUND ( MHz ) = CENTER\_FREQ ( BW ) / 2$$

For each index of the frequency overlap array, the UE determines 408 the upper bound (UPPER_BOUND) of the RF channel based on the center frequency and BW. For example, the center frequency and BW relates to the upper bound as follows:

$$UPPER\_BOUND ( MHz ) = CENTER\_FREQ + ( BW ) / 2$$

Further, the UE may sort 410 the frequency overlap array by ARFCN, e.g., in increasing order.

For each index of the frequency overlap array, the UE determines 412 whether the upper bound of the current index (e.g., index=i) is greater than the lower bound of the next index (e.g., of index i+1). Alternatively, the UE may determine whether the lower bound of the current index (e.g., index=i) is less than the upper bound of the next index (e.g., of index i+1).

If no index (i.e., entry) has an upper bound that is greater than the lower bound of another index, then there is no overlap. In such cases, the UE may set 414 an overlap status as “false” for the current index of the frequency overlap array.

Otherwise, if an upper bound of one index (i.e., entry) is greater than the lower bound of another index, then there is overlap and the UE may set 416 an overlap status as “true” for the current index of the frequency overlap array.

When the overlap status is “true” for the current index, the UE may determine 418 an overlap amount (OVERLAP_AMOUNT) based on the difference between the upper bound of the current index and the lower bound of the next index. In some implementations, the overlap amount may also include a difference between the lower bound of the previous index and the upper bound of the current index, i.e., to account for overlaps at both the upper and lower portions of the RF channel.

For each index having an overlap status set to “true,” the UE may determine 420 an updated maximum supported bandwidth (NEW_BW) based on the total (e.g., summed) amounts of overlap. In some implementations, the updated maximum supported bandwidth (NEW_BW) may be determined using the minimum bandwidth among the indices having an overlap status set to “true,” less the summed overlap amounts. For example, in the potential interference condition of FIG. 2, the minimum bandwidth among the overlapping RF channels is 90 MHz. There is a 5 MHz overlap for each RF channel, thus the updated maximum supported bandwidth is as follows:

$$NEW\_BW ( MHz ) = 90 MHz - ( 5 MHz + 5 MHz ) = 80 MHz$$

In this example, the 5 MHz overlap is accounted for twice in the frequency overlap, and this NEW_BW is 80 MHz, which avoids the potential interference. The procedure 400 ends with the updated maximum supported bandwidth(s).

In some implementations, the updated maximum supported bandwidth(s) may be returned to the UE for signaling to the wireless network. After receiving the UE-determined updated maximum supported bandwidth(s), the wireless network may accept the operating bandwidth restrictions indicated by the maximum supported bandwidth(s), thereby precluding allocation of RF resources in the overlapping spectra to the UE.

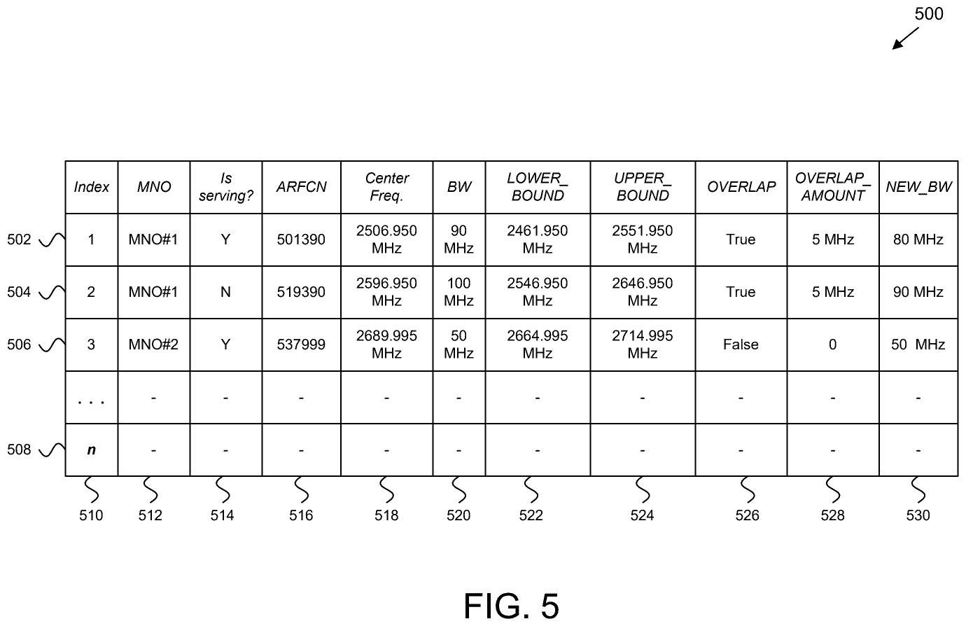

FIG. 5 illustrates an example of frequency overlap array 500, in accordance with aspects of the present disclosure. The frequency overlap array 500 may implement or be implemented by aspects of the wireless communication system 100. For example, the frequency overlap array 500 may be generated by a UE, which may be an example of the UE 104, as described herein.

In some implementations, the frequency overlap array 500 may be generated by the procedure 400. In certain implementations, the frequency overlap array 500 may be generated by the UE after a SD scan, such as during the procedure 300 for determining a potential RF interference condition and determining an updated maximum supported bandwidth for a RF channel. In other implementations, the frequency overlap array 500 may be generated by the UE after examining OTA overheads (i.e., SI broadcasts and/or RRC signaling).

In some implementations, the frequency overlap array 500 is a two dimensional array, e.g., a table of cell information with each table entry corresponding to a vector of the frequency overlap array 500. In the depicted arrangement, there are N vectors in the frequency overlap array 500 (e.g., rows 1 . . . n), including a first vector 502 corresponding to a first cell, a second vector 504 corresponding to a second cell, a third vector 506 corresponding to a third cell, and an n^{th} vector 508 corresponding to an n^{th} cell.

In some implementations, a first element 510 of each vector stores the vector index. In certain implementations, the vectors (e.g., rows) of the frequency overlap array 500 may be sorted by ARFCN in increasing order.

In some implementations, a second element 512 of each vector stores the MNO (e.g., service provider) for the associated cell. In certain implementations, the MNO identity may be a mobile network code (MNC) or a PLMN identifier comprising the MNC and mobile country code (MCC). In some examples, a character string, such as a three-letter code, may be used to identify the MNO.

In some implementations, a third element 514 of each vector stores an indication of whether the cell is a serving cell for the UE. For example, a serving cell may be a primary cell (PCell), a primary secondary cell (PSCell), or a secondary cell (SCell). For a DSDS UE, there may be more than one serving cell at a time and the service cells may be associated with different MNOs. Note however, that only one SIM of the DSDS UE may be active at a particular time, with the other SIM being in standby during the time the first SIM is active. In some other implementations of the frequency overlap array 500, the serving cell may be omitted.

In some implementations, a fourth element 516 of each vector stores the ARFCN for the associated cell. As described above, the vectors (e.g., rows) of the frequency overlap array 500 may be sorted by ARFCN in increasing order.

In some implementations, a fifth element 518 of each vector stores the center frequency for the associated cell. As described above, there may be a mathematical relation between the ARFCN and the center frequency. Thus, the vectors (e.g., rows) may also be sorted by center frequency in increasing order.

In some implementations, a sixth element 520 of each vector stores the cell bandwidth (BW) for the associated cell. In certain implementations, the cell bandwidth is a default maximum supported bandwidth for the associated cell.

In some implementations, a seventh element 522 of each vector stores the lower bound (LOWER_BOUND) frequency of the associated cell. As described above, the lower bound may be determined from the center frequency and the cell bandwidth.

In some implementations, an eighth element 524 of each vector stores the upper bound (UPPER_BOUND) frequency of the associated cell. As described above, the upper bound may also be determined from the center frequency and the cell bandwidth.

In some implementations, a ninth element 526 of each vector stores an overlap indication. As described above, the overlap indication may be set to ‘True’ whenever the upper bound frequency of one cell is higher than the lower bound frequency of the next cell in increasing order of center frequency.

In some implementations, a tenth element 528 of each vector stores an amount of overlap (OVERLAP_AMOUNT). As described above, the overlap amount is based on the upper bound frequency of one cell and the lower bound frequency of the next cell. When the overlap indication is set to ‘False,’ the value in the overlap amount may be set to ‘0’ or null. In certain implementations, the tenth element 528 may be omitted from the vector when the overlap indication is set to ‘False.’

In some implementations, an eleventh element 530 of each vector stores the updated (i.e., modified) maximum supported bandwidth (NEW_BW) for the associated cell. In certain implementations, the updated maximum supported bandwidth overlap is based on the cell bandwidth and the amount of frequency overlap. The updated maximum supported bandwidth is centered on same center frequency (i.e., ARFCN still points to the center of the modified bandwidth) and is set so that new bandwidth excludes the overlapping spectra. When the overlap indication is set to ‘True,’ the updated maximum supported bandwidth in element 530 has a value less than the cell bandwidth in element 520. When the overlap indication is set to ‘False,’ then value in the overlap amount may be set to null or to the same value as the cell bandwidth in element 520. In certain implementations, the eleventh element 530 may be omitted from the vector when the overlap indication is set to ‘False.’

In the depicted example, the UE determines the updated maximum supported bandwidth for the first cell (e.g., vector 502) to be 80 MHz. In some implementations, the UE may transition from signaling for a given RF band supportedBandwidthDL/UL fr1: mhz100 (i.e., the initial/default maximum supported bandwidth for the first cell), to signaling supportedBandwidthDL/UL fr1: mhz80 (i.e., the updated maximum supported bandwidth for the first cell), in a UeCapabilityInformation message sent to the wireless network.

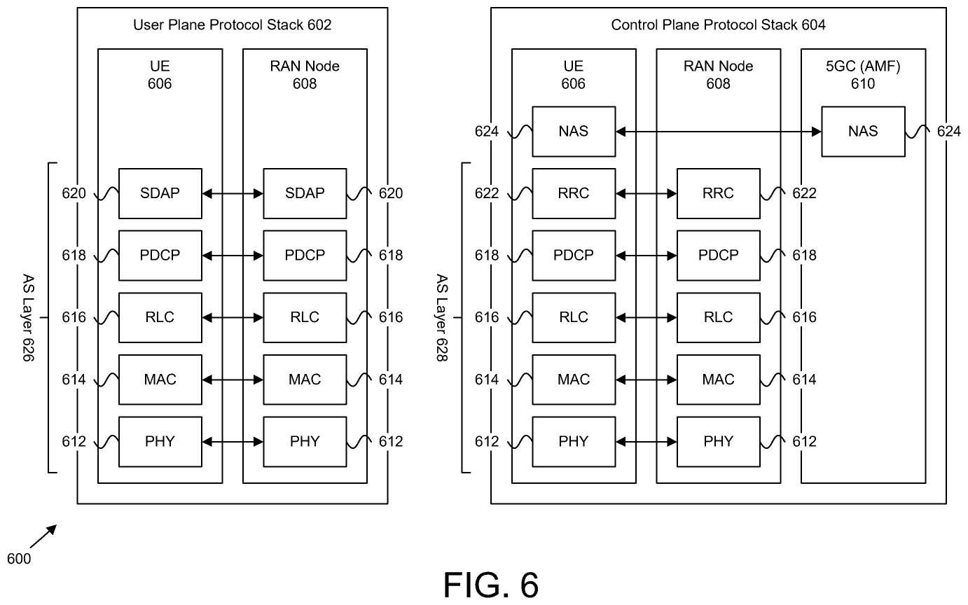

FIG. 6 illustrates an example of a protocol stack 600, in accordance with aspects of the present disclosure. While FIG. 6 shows a UE 606, a RAN node 608, and a 5GC 610 (e.g., comprising at least an AMF), these are representative of a set of UEs 104 interacting with an NE 102 (e.g., base station) and a CN 106. As depicted, the protocol stack 600 comprises a user plane protocol stack 602 and a control plane protocol stack 604. The user plane protocol stack 602 includes a physical (PHY) layer 612, a MAC sublayer 614, a radio link control (RLC) sublayer 616, a packet data convergence protocol (PDCP) sublayer 618, and a service data adaptation protocol (SDAP) sublayer 620. The control plane protocol stack 604 includes a PHY layer 612, a MAC sublayer 614, an RLC sublayer 616, and a PDCP sublayer 618. The Control Plane protocol stack 604 also includes an RRC layer 622 and a non-access stratum (NAS) layer 624.

The AS layer 626 (also referred to as “AS protocol stack”) for the user plane protocol stack 602 consists of at least the SDAP sublayer 620, the PDCP sublayer 618, the RLC sublayer 616, the MAC sublayer 614, and the PHY layer 612. The AS layer 628 for the control plane protocol stack 604 consists of at least the RRC layer 622, the PDCP sublayer 618, the RLC sublayer 616, the MAC sublayer 614, and the PHY layer 612. The layer-1 (L1) includes the PHY layer 612. The layer-2 (L2) is split into the SDAP sublayer 620, PDCP sublayer 618, RLC sublayer 616, and MAC sublayer 614. The layer-3 (L3) includes the RRC layer 622 and the NAS layer 624 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 612 offers transport channels to the MAC sublayer 614. The PHY layer 612 may perform a beam failure detection procedure using energy detection thresholds, as described herein. In certain implementations, the PHY layer 612 may send an indication of beam failure to a MAC entity at the MAC sublayer 614. The MAC sublayer 614 offers logical channels (LCHs) to the RLC sublayer 616. The RLC sublayer 616 offers RLC channels to the PDCP sublayer 618.

The PDCP sublayer 618 offers radio bearers to the SDAP sublayer 620 and/or RRC layer 622. The SDAP sublayer 620 offers QoS flows to the core network (e.g., 5GC). The RRC layer 622 provides for the addition, modification, and release of carrier aggregation (CA) and/or dual connectivity. The RRC layer 622 also manages the establishment, configuration, maintenance, and release of signaling radio bearers (SRBs) and data radio bearers (DRBs).

The NAS layer 624 is between the UE 606 and an AMF in the 5GC 610. NAS messages are passed transparently through the RAN. The NAS layer 624 is used to manage the establishment of communication sessions and for maintaining continuous communication with the UE 606 as it moves between different cells of the RAN. In contrast, the AS layers 626 and 628 are between the UE 606 and the RAN (i.e., RAN node 608) and carry information over the wireless portion of the network. While not depicted in FIG. 6, the IP layer exists above the NAS layer 624, a transport layer exists above the IP layer, and an application layer exists above the transport layer.

The MAC sublayer 614 is the lowest sublayer in the L2 architecture of the NR protocol stack. Its connection to the PHY layer 612 below is through transport channels, and the connection to the RLC sublayer 616 above is through LCHs. The MAC sublayer 614 therefore performs multiplexing and demultiplexing between LCHs and transport channels: the MAC sublayer 614 in the transmitting side constructs MAC PDUs (also known as transport blocks (TBs)) from MAC service data units (SDUs) received through LCHs, and the MAC sublayer 614 in the receiving side recovers MAC SDUs from MAC PDUs received through transport channels.

The MAC sublayer 614 provides a data transfer service for the RLC sublayer 616 through LCHs, which are either control LCHs which carry control data (e.g., RRC signaling) or traffic LCHs which carry user plane data. On the other hand, the data from the MAC sublayer 614 is exchanged with the PHY layer 612 through transport channels, which are classified as UL or DL. Data is multiplexed into transport channels depending on how it is transmitted over the air.

The PHY layer 612 is responsible for the actual transmission of data and control information via the air interface, i.e., the PHY layer 612 carries all information from the MAC transport channels over the air interface on the transmission side. Some of the important functions performed by the PHY layer 612 include coding and modulation, link adaptation (e.g., adaptive modulation and coding (AMC)), power control, cell search and random access (for initial synchronization and handover purposes) and other measurements (inside the 3rd generation partnership project (3GPP) system (i.e., NR and/or LTE system) and between systems) for the RRC layer 622. The PHY layer 612 performs transmissions based on transmission parameters, such as the modulation scheme, the coding rate (i.e., the modulation and coding scheme (MCS)), the number of physical resource blocks (PRBs), etc.

In some implementations, the protocol stack 600 may be an NR protocol stack used in a 5G NR system. Note that an LTE protocol stack comprises similar structure to the protocol stack 600, with the differences that the LTE protocol stack lacks the SDAP sublayer 620 in the AS layer 626, that an EPC replaces the 5GC 610, and that the NAS layer 624 is between the UE 606 and an MME in the EPC. Also note that the present disclosure distinguishes between a protocol layer (such as the aforementioned PHY layer 612, MAC sublayer 614, RLC sublayer 616, PDCP sublayer 618, SDAP sublayer 620, RRC layer 622 and NAS layer 624) and a transmission layer in MIMO communication (also referred to as a “MIMO layer” or a “data stream”).

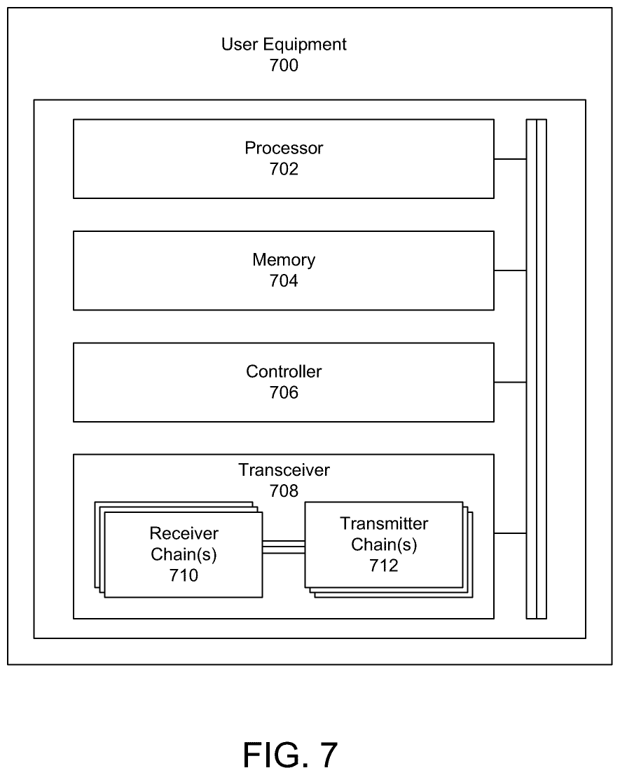

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform various functions (e.g., operations, signaling) described herein (e.g., executing, by the processor 702, instructions stored in the memory 704). In some implementations, the processor 702 may include multiple processors and the memory 704 may include multiple memories. One or more of the multiple processors may be coupled with one or more of the multiple memories, which may be individually or collectively, configured to perform various functions (e.g., operations, signaling) of the UE 700 as described herein.

The processor 702 coupled with the memory 704 may be configured to, capable of, or operable to cause the UE 700 to detect at least two selection-suitable cells of similar pathloss on a frequency range, each cell associated with a RF channel; determine a potential RF interference condition between the at least two selection-suitable cells due to overlapping spectra of the associated RF channels; determine, for the frequency range, updated maximum supported bandwidths of the UE; and transmit, to a wireless network, an indication of at least one updated maximum supported bandwidth.

In some implementations, the processor 702 coupled with the memory 704 may be configured to cause the UE 700 to: A) determine that the UE 700 encounters a failure condition; B) determine that the UE 700 satisfies a stationary threshold; and C) detect the at least two selection-suitable cells in response to the failure condition and the stationary threshold being satisfied.

In certain implementations, the failure condition includes: 1) a communication failure, 2) a dropped call, 3) a detected quality that falls below a quality threshold, 4) a radio link failure, 5) a data stall condition, or any combination thereof.

In some implementations, the processor 702 coupled with the memory 704 may be configured to cause the UE 700 to adjust an operating bandwidth for each RF channel in response to the potential RF interference condition. In such implementations, the operating bandwidth may be an updated maximum supported bandwidth for the RF channel associated with a serving cell.

In some implementations, the processor 702 coupled with the memory 704 may be configured to cause the UE 700 to: A) determine that the UE 700 satisfies a mobility threshold; and B) revert the updated maximum supported bandwidths in response to the mobility threshold being satisfied.

In some implementations, the processor 702 coupled with the memory 704 may be configured to cause the UE 700 to determine an amount of spectrum overlap by subtracting upper and lower bounds of adjacent frequencies of the at least two selection-suitable cells.

In some implementations, to determine, for the frequency range, the updated maximum supported bandwidths of the UE 700, the processor 702 coupled with the memory 704 may be configured to cause the UE 700 to reduce the updated maximum supported bandwidths based on the determined amount of spectrum overlap. In certain implementations, the at least one updated maximum supported bandwidth includes a minimum bandwidth among the at least two selection-suitable cells minus a sum of all amounts of spectrum overlap.

In some implementations, the processor 702 coupled with the memory 704 may be configured to cause the UE 700 to: A) receive over-the-air (OTA) overhead information for the at least two selection-suitable cells; and B) determine the overlapping spectra from the OTA overhead information.

In some implementations, to transmit the indication of the at least one updated maximum supported bandwidth, the processor 702 coupled with the memory 704 may be configured to cause the UE 700 to transmit a UCI update message.

In certain implementations, the UE 700 includes multiple SIMs operating on different wireless networks, wherein the at least two selection-suitable cells include at least one selection-suitable cell on each of the different wireless network, and wherein transmitting the indication of the at least one updated maximum supported bandwidth includes transmitting the UCI update message to at least one of the different wireless networks.

In some implementations, to detect the at least two selection-suitable cells, the processor 702 coupled with the memory 704 may be configured to cause the UE 700 to detect a plurality of cells having a RSRP value that satisfies a power threshold or a RSRQ value that satisfies a quality threshold, or both.

In some implementations, the processor 702 coupled with the memory 704 may be configured to cause the UE 700 to: A) determine the center frequencies of the at least two selection-suitable cells; and B) determine a respective bandwidth of each of the at least two selection-suitable cells, centered on a respective center frequency. In such implementations, the overlapping spectra of the associated RF channels includes a set of consecutive subcarriers common to the at least two selection-suitable cells.

In some implementations, the at least two selection-suitable cells of similar pathloss have different center frequencies and the processor 702 coupled with the memory 704 may be configured to cause the UE 700 to transmit, to the wireless network, an indication of an inter-frequency interference condition based on the potential RF interference condition.

In certain implementations, the indication of an inter-frequency interference condition includes a UE assistance information (UAI) message that includes: 1) an ARFCN of at least one RF channel of the associated RF channels; 2) a frequency offset of the overlapping spectra relative to the center frequency of the at least one RF channel; 3) an amount of spectrum overlap; or any combination thereof.

In other implementations, the at least two selection-suitable cells of similar pathloss have the same center frequencies and the processor 702 coupled with the memory 704 may be configured to cause the UE 700 to transmit, to the wireless network, an indication of an intra-frequency interference condition based on the potential RF interference condition.

In some implementations, the processor 702 coupled with the memory 704 may be configured to cause the UE 700 to receive the PDSCH, where the received PDSCH includes a second DCI. In such implementations, the second DCI indicates the second resource allocation of the second set of resources for transmission of at least one or multiple PUSCH. In certain implementations, the second DCI allocates further indicates an allocation of downlink resources for at least one second PDSCH.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

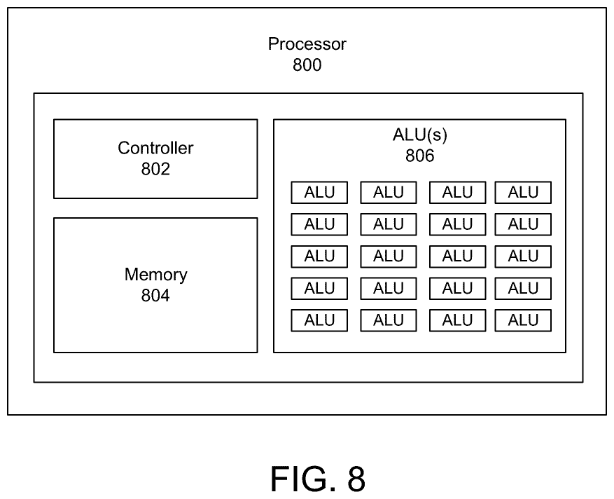

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1, or L2, or L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

In some implementations, the processor 800 may support various functions (e.g., operations, signaling) of a UE, in accordance with examples as disclosed herein. For example, the controller 802 coupled with the memory 804 may be configured to, capable of, or operable to cause the processor 800 to detect at least two selection-suitable cells of similar pathloss at on a frequency range, each cell associated with a RF channel; determine a potential RF interference condition between the at least two selection-suitable cells due to overlapping spectra of the associated RF channels; determine, for the frequency range, updated maximum supported bandwidths of the UE; and transmit, to a wireless network, an indication of at least one updated maximum supported bandwidth. Additionally, the controller 802 coupled with the memory 804 may be configured to, capable of, or operable to cause the processor 800 to perform one or more functions (e.g., operations, signaling) of the UE as described herein.

Additionally, or alternatively, in some other implementations, the processor 800 may support various functions (e.g., operations, signaling) of a base station, in accordance with examples as disclosed herein. For example, the controller 802 coupled with the memory 804 may be configured to, capable of, or operable to cause the processor 800 to receive, from a stationary UE, a first indication of an updated maximum supported bandwidth of the UE; adjust one or more allocation of RF resources to the UE based on the first indication; and receive a second indication of an interference condition based on potential RF interference condition between at least two selection-suitable cells on a frequency range due to overlapping spectra of associated RF channels. Additionally, the controller 802 coupled with the memory 804 may be configured to, capable of, or operable to cause the processor 800 to perform one or more functions (e.g., operations, signaling) of the base station as described herein.

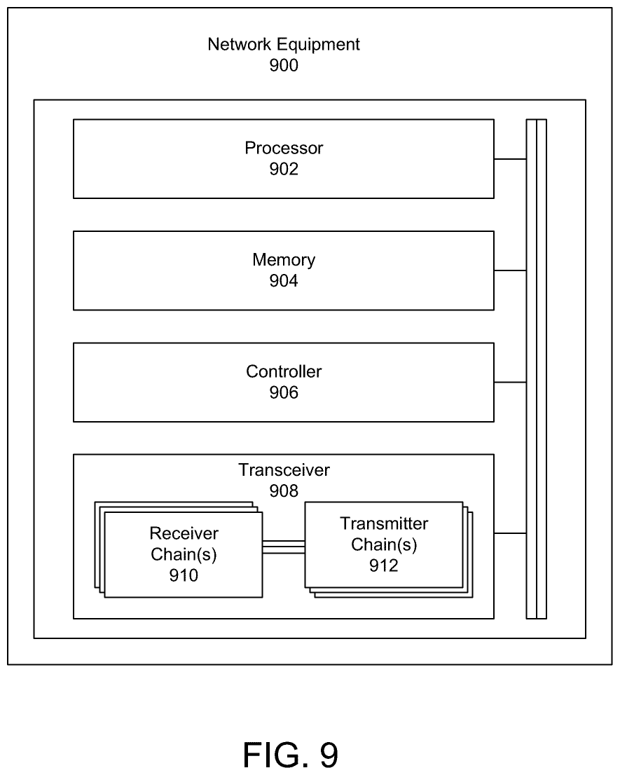

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform various functions (e.g., operations, signaling) described herein (e.g., executing, by the processor 902, instructions stored in the memory 904). In some implementations, the processor 902 may include multiple processors and the memory 904 may include multiple memories. One or more of the multiple processors may be coupled with one or more of the multiple memories, which may be individually or collectively, configured to perform various functions (e.g., operations, signaling) of the NE 900 as described herein.

For example, the processor 902 coupled with the memory 904 may be configured to, capable of, or operable to cause the NE 900 to receive, from a stationary UE, a first indication of an updated maximum supported bandwidth of the UE; adjust one or more allocation of RF resources to the UE based on the first indication; and receive a second indication of an interference condition based on potential RF interference condition between at least two selection-suitable cells on a frequency range due to overlapping spectra of associated RF channels.

In some implementations, to receive the second indication, the processor 902 coupled with the memory 904 may be configured to cause the NE 900 to receive a UAI message that includes: 1) an ARFCN of at least one RF channel of the associated RF channels; 2) a frequency offset of the overlapping spectra relative to the center frequency of the at least one RF channel; 3) an amount of spectrum overlap; or any combination thereof.

In some implementations, each RF channel includes a bandwidth centered on a respective center frequency, and wherein the maximum supported bandwidth for the frequency range includes a minimum bandwidth among the at least two selection-suitable cells minus a sum of all spectra overlap amounts.

In some implementations, to receive the indication of the updated maximum supported bandwidth, the processor 902 coupled with the memory 904 may be configured to cause the NE 900 to receive a UCI update message.

In some implementations, to adjust the one or more allocation of RFs resources to the UE based on the first indication, the processor 902 coupled with the memory 904 may be configured to cause the NE 900 to: A) adjust an operating bandwidth for at least one RF channel of the associated RF channels based on the updated maximum supported bandwidth of the UE; and B) indicate the adjusted operating bandwidth to the UE.

In some implementations, the processor 902 coupled with the memory 904 may be configured to cause the NE 900 to: A) receive a third indication that the UE satisfies a mobility threshold; and B) revert the operating bandwidth for the at least one RF channel in response to the UE satisfying the mobility threshold.

In certain implementations, the indication of the interference condition includes a UAI message that includes: 1) an ARFCN of at least one RF channel of the associated RF channels; 2) a frequency offset of the overlapping spectra relative to the center frequency of the at least one RF channel; 3) an amount of spectrum overlap; or any combination thereof.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

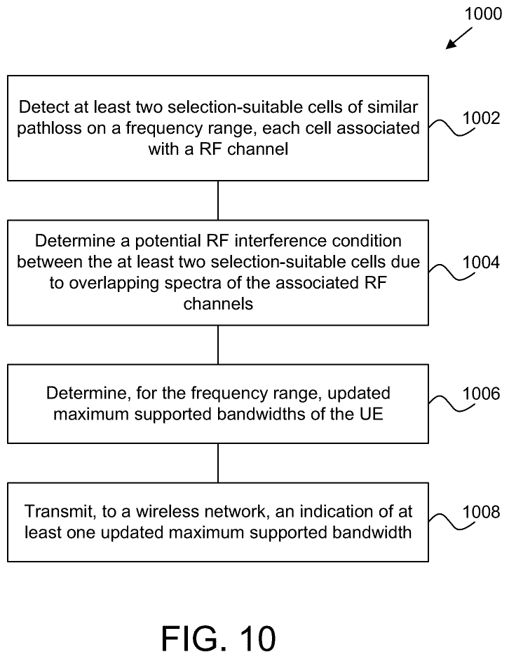

FIG. 10 illustrates a flowchart of a method 1000 in accordance with aspects of the present disclosure. The operations of the method 1000 may be implemented by a UE as described herein. In some implementations, the UE may execute a set of instructions to control the function elements of a processor to perform the described functions.

At step 1002, the method 1000 may include detecting at least two selection-suitable cells of similar pathloss on a frequency range, each cell associated with a RF channel. The operations of step 1002 may be performed in accordance with examples as described herein. In some implementations, aspects of the operations of step 1002 may be performed by a UE, as described with reference to FIG. 7.

At step 1004, the method 1000 may include determining a potential RF interference condition between the at least two selection-suitable cells due to overlapping spectra of the associated RF channels. The operations of step 1004 may be performed in accordance with examples as described herein. In some implementations, aspects of the operations of step 1004 may be performed by a UE, as described with reference to FIG. 7.

At step 1006, the method 1000 may include determining, for the frequency range, updated maximum supported bandwidths of the UE. The operations of step 1006 may be performed in accordance with examples as described herein. In some implementations, aspects of the operations of step 1006 may be performed by a UE, as described with reference to FIG. 7.

At step 1008, the method 1000 may include transmitting, to a wireless network, an indication of at least one updated maximum supported bandwidth. The operations of step 1008 may be performed in accordance with examples as described herein. In some implementations, aspects of the operations of step 1008 may be performed by a UE, as described with reference to FIG. 7.

It should be noted that the method 1000 described herein describes one possible implementation, and that the operations and the steps may be rearranged or otherwise modified and that other implementations are possible.

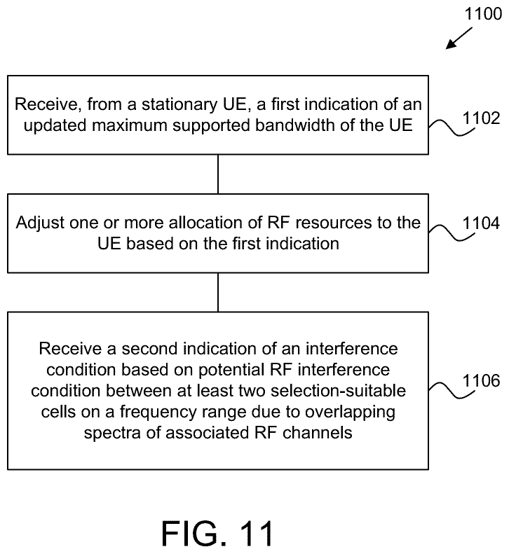

FIG. 11 illustrates a flowchart of a method 1100 in accordance with aspects of the present disclosure. The operations of the method 1100 may be implemented by a NE as described herein. In some implementations, the NE may execute a set of instructions to control the function elements of a processor to perform the described functions.

At step 1102, the method 1100 may include receiving, from a stationary UE, a first indication of an updated maximum supported bandwidth of the UE. The operations of step 1102 may be performed in accordance with examples as described herein. In some implementations, aspects of the operations of step 1102 may be performed by a NE, as described with reference to FIG. 9.

At step 1104, the method 1100 may include adjusting one or more allocation of RF resources to the UE based on the first indication. The operations of step 1104 may be performed in accordance with examples as described herein. In some implementations, aspects of the operations of step 1104 may be performed by a NE, as described with reference to FIG. 9.

At step 1106, the method 1100 may include receiving a second indication of an interference condition based on potential RF interference condition between at least two selection-suitable cells on a frequency range due to overlapping spectra of associated RF channels. The operations of step 1106 may be performed in accordance with examples as described herein. In some implementations, aspects of the operations of step 1106 may be performed by a NE, as described with reference to FIG. 9.

It should be noted that the method 1100 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method performed by a user equipment (UE), the method comprising:
detecting at least two selection-suitable cells of similar pathloss on a frequency range, each cell associated with a radio frequency (RF) channel;
determining a potential RF interference condition between the at least two selection-suitable cells due to overlapping spectra of the associated RF channels;
determining, for the frequency range, updated maximum supported bandwidths of the UE; and
transmitting, to a wireless network, an indication of at least one updated maximum supported bandwidth.

2. The method of claim 1, further comprising:
determining that the UE encounters a failure condition;
determining that the UE satisfies a stationary threshold; and
detecting the at least two selection-suitable cells in response to the failure condition and the stationary threshold being satisfied.

3. The method of claim 2, wherein the failure condition comprises a communication failure, a dropped call, a detected quality that falls below a quality threshold, a radio link failure, or a data stall condition.

4. The method of claim 1, further comprising:
adjusting an operating bandwidth for each RF channel in response to the potential RF interference condition,
wherein the operating bandwidth is an updated maximum supported bandwidth for the RF channel associated with a serving cell.

5. The method of claim 1, further comprising:
determining that the UE satisfies a mobility threshold; and
reverting the updated maximum supported bandwidths in response to the UE satisfying the mobility threshold.

6. The method of claim 1, further comprising:
determining an amount of spectrum overlap by subtracting upper and lower bounds of adjacent frequencies of the at least two selection-suitable cells,
wherein determining, for the frequency range, the updated maximum supported bandwidths of the UE comprises reducing the updated maximum supported bandwidths based on the determined amount of spectrum overlap, and
wherein the at least one updated maximum supported bandwidth comprises a minimum bandwidth among the at least two selection-suitable cells minus a sum of all amounts of spectrum overlap.

7. The method of claim 1, further comprising:
receiving over-the-air (OTA) overhead information for the at least two selection-suitable cells; and
determining the overlapping spectra from the OTA overhead information.

8. The method of claim 1, wherein transmitting the indication of the at least one updated maximum supported bandwidth comprises transmitting a UE capability information (UCI) update message.

9. The method of claim 8, wherein the UE comprises multiple subscriber identity modules (SIMs) operating on different wireless networks, wherein the at least two selection-suitable cells comprise at least one selection-suitable cell on each of the different wireless network, and wherein transmitting the indication of the at least one updated maximum supported bandwidth comprises transmitting the UCI update message to at least one of the different wireless networks.

10. The method of claim 1, wherein detecting the at least two selection-suitable cells comprises detecting a plurality of cells having a reference signal received power (RSRP) value that satisfies a power threshold or a reference signal received quality (RSRQ) value that satisfies a quality threshold, or both.

11. The method of claim 1, further comprising:
determining center frequencies of the at least two selection-suitable cells; and
determining a respective bandwidth of each selection-suitable cell, centered on a respective center frequency,
wherein the overlapping spectra of the associated RF channels comprises a set of consecutive subcarriers common to the at least two selection-suitable cells.

12. The method of claim 1, wherein the at least two selection-suitable cells of similar pathloss have different center frequencies, the method further comprising:
transmitting, to the wireless network, an indication of an inter-frequency interference condition based on the potential RF interference condition.

13. The method of claim 12, wherein the indication of an inter-frequency interference condition comprises a UE assistance information (UAI) message comprising one or more of:
an absolute radio frequency channel number (ARFCN) of at least one RF channel of the associated RF channels;
a frequency offset of the overlapping spectra relative to a center frequency of the at least one RF channel; or
an amount of spectrum overlap.

14. A user equipment (UE) for wireless communication, comprising:
at least one memory; and
at least one processor coupled with the at least one memory and configured to cause the UE to:
detect at least two selection-suitable cells of similar pathloss on a frequency range, each cell associated with a radio frequency (RF) channel;
determine a potential RF interference condition between the at least two selection-suitable cells due to overlapping spectra of the associated RF channels;
determine, for the frequency range, updated maximum supported bandwidths of the UE; and
transmit, to a wireless network, an indication of at least one updated maximum supported bandwidth.

15. The UE of claim 14, wherein the at least one processor is configured to cause the UE to:
determine that the UE encounters a failure condition;
determine that the UE satisfied a stationary threshold;
detect the at least two selection-suitable cells in response to the failure condition and the stationary threshold being satisfied;
determine that the UE satisfies a mobility threshold; and
revert the maximum bandwidths in response to the UE satisfying the mobility threshold.

16. The UE of claim 14, further comprising multiple subscriber identity modules (SIMs) operating on different wireless networks, wherein the at least two selection-suitable cells comprise at least one selection-suitable cell on each of the different wireless network, and wherein the at least one processor is configured to cause the UE to transmit a UE capability information (UCI) update message to at least one of the different wireless networks.

17. A base station for wireless communication, comprising:
at least one memory; and
at least one processor coupled with the at least one memory and configured to cause the base station to:
receive, from a stationary user equipment (UE), a first indication of an updated maximum supported bandwidth of the UE;
adjust one or more allocation of radio frequency (RF) resources to the UE based on the first indication; and
receive a second indication of an interference condition based on potential RF interference condition between at least two selection-suitable cells on a frequency range due to overlapping spectra of associated RF channels.

18. The base station of claim 17, wherein to receive the second indication, the at least one processor is configured to cause the base station to receive a UE assistance information (UAI) message comprising one or more of:
an absolute radio frequency channel number (ARFCN) of at least one RF channel of the associated RF channels;
a frequency offset of the overlapping spectra relative to a center frequency of the at least one RF channel; or
an amount of spectrum overlap.

19. The base station of claim 17, wherein each RF channel comprises a bandwidth centered on a respective center frequency, and wherein the maximum supported bandwidth for the frequency range comprises a minimum bandwidth among the at least two selection-suitable cells minus a sum of all spectrum overlap amounts.

20. The base station of claim 17, wherein to receive the indication of the updated maximum supported bandwidth, the at least one processor is configured to cause the base station to receive a UE capability information (UCI) update message.
